(19) United States
(12) Patent Application Publication
(10) Pub. No.: US 2004/0212196 A1
(43) Pub. Date: Oct. 28, 2004

(54) Vehicle movement detection circuit

(76) Inventor: James R. Marcoz, East McKeesport, PA (US)

Correspondence Address: JAMES RAY & ASSOCIATES, 2640 PITCAIRN ROAD, MONROEVILLE, PA, 15146, US

(21) Appl. No.: 10/421,058

(22) Filed: Apr. 23, 2003

(51) Int. Cl. H02P 9/04; F02N 11/00

(52) U.S. Cl. 290/38 R

(57) ABSTRACT

A vehicle movement detection circuit can be used as a remote starter circuit for a vehicle with a manual transmission. The detection circuit receives a rotation sensor output signal indicating the rotation of a wheel or a drive shaft to determine if the manual transmission is in gear when the vehicle is being started remotely. If the rotation is sensed, the remote starter circuit disables the control circuitry for the starter motor in the remote starter module. The vehicle movement detection circuit can also be used to alert a driver that a piece of equipment has not been properly stowed for travel when the driver first begins driving the vehicle. Alternatively, or in addition, the equipment not properly stowed can be automatically stowed when the driver first begins driving the vehicle.

### BACKGROUND OF THE INVENTION

1. Field of the Invention

This invention relates to circuitry for sensing vehicle movement, and, more particularly, for sensing forward and rearward movement vehicle movement.

2. Description of Related Art

Vehicle movement detection circuits can be used in a variety of applications including use with remote starters. Remote starters, which have a remote module and an in-vehicle module, enable someone with the remote module to start the vehicle without having to be in the vehicle. The prior art remote starters have generally only been available for vehicles with automatic transmissions since automatic transmissions have an electrical output terminal which indicates whether the transmission is in park or not while manual transmissions generally do not.

Various solutions have been put forth in the prior art. The most common solution is to require the driver to follow a set procedure for turning off the engine, such as requiring the driver to exit the vehicle with the engine running and then to turn off the engine with the remote module. One type of this solution is described in U.S. Pat. No. 5,656,868 to Gottlieb et al. Another solution is to install mechanical hardware in the car to sense the position of the gear shift to verify that the transmission is in neutral. U.S. Pat. No. 5,646,457 to Vakavtchiev and U.S. Pat. No. 5,614,883 to Dery et al. describe this solution. A third solution put forth is to install a motion detector to sense forward or rearward motions which are greater than the motions produced when the engine is being started. The sensor must not detect an engine starting vibration but must detect a lurch forward or backward. Such a solution is described in U.S. Pat. No. 4,345,554 to Hildreth et al. These solutions require either conformation to an engine shutdown procedures which complicates the use of the vehicle, expensive modifications to the vehicle or sensors which must be properly aligned with the front and rear of the vehicle when installed.

### BRIEF SUMMARY OF THE INVENTION

In one aspect the present invention generally features a remote starter circuit for a vehicle equipped with a manual transmission. The vehicle is equipped with a rotation sensor which senses the rotation of a part of the vehicle which rotates when the vehicle is moving. The remote starter circuit then inhibits the remote starter from attempting to start an engine of the vehicle if rotation is sensed.

In a further aspect of this invention the rotation sensor is a wheel rotation sensor or a drive shaft rotation sensor.

Another aspect of this invention is to provide a remote starter circuit means for a vehicle with a manual transmission equipped with a rotation sensor means which senses the rotation of a part of the vehicle which rotates when the vehicle is moving. A switching means, responsive to the rotation, inhibits starting the engine when the remote starter would otherwise start the engine.

A still further aspect of this invention is to provide a method for preventing a vehicle engine from being started by a remote starter when the vehicle has a manual transmission. When a forward or rearward movement of the vehicle is detected, the remote starter is inhibited from starting the engine of the vehicle.

Yet another aspect of this invention is to detect movement of a vehicle when a driver starts driving the vehicle.

### OBJECTS OF THE INVENTION

It is, therefore, one of the primary objects of the present invention to provide a remote starter circuit for manual transmission vehicles which eliminates the need for a required engine shutdown procedure.

Another object of the present invention, is to provide a remote starter circuit for manual transmission vehicles which does not require the installation of additional mechanical hardware.

Yet another object, of the present invention, is to provide an easily installed remote starter add-on module to an in-vehicle module for vehicles with manual transmissions, or a remote starter circuit for vehicles with manual transmissions which is included in the in-vehicle module.

A further object, of the present invention, is to provide a circuit for detecting movement of a vehicle to alert a driver of a piece of equipment which has not been stowed prior to the driver starting to drive the vehicle.

In addition to the above-described objects and advantages of the present invention, various other objects and advantages will become more readily apparent to those persons who are skilled in the same and related arts from the following more detailed description on the invention, particularly, when such description is taken in conjunction with the attached drawing and appended claims.

### DESCRIPTION OF THE DRAWING

The aforementioned and other features, characteristics, advantages, and the invention in general will be better understood from the following more detailed description taken in conjunction with the accompanying drawings, in which:

FIG. 1 shows a schematic diagram of a circuit for a vehicle movement detection circuit according to the present invention; and

FIG. 2 is a recreation vehicle with the present invention.

It will be appreciated that the various elements in the drawings have not necessarily been drawn to scale in order to better show the features of the invention.

### DETAILED DESCRIPTION OF THE PREFERRED EMBODIMENT

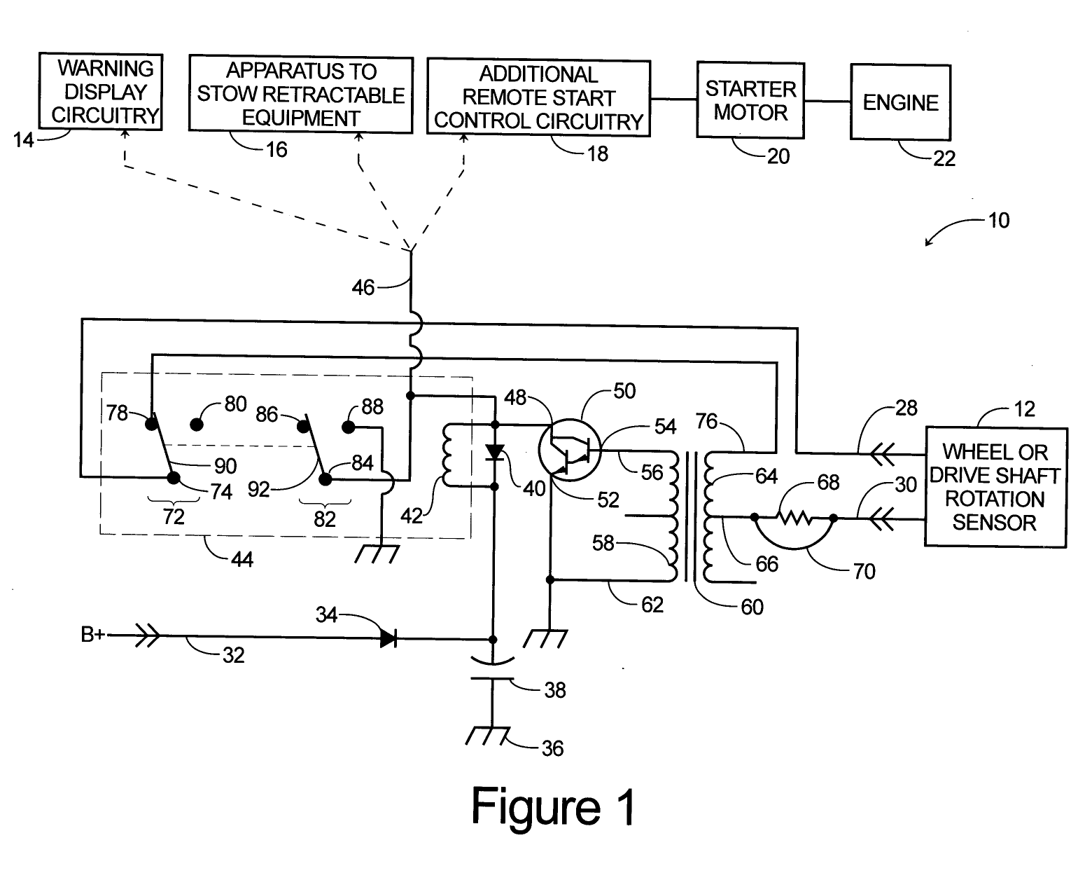

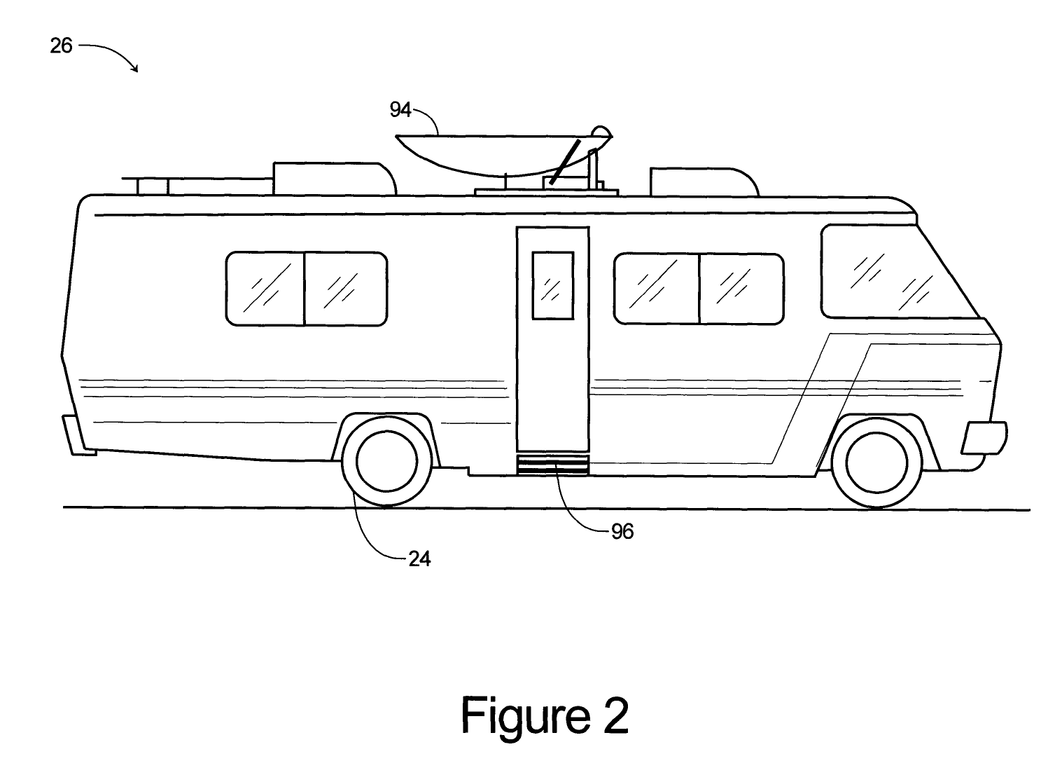

Turning now to the drawing, FIG. 1 shows a schematic diagram of a circuit for a vehicle movement detection circuit, according to the present invention, which can used, for example, in conjunction with a remote starter. In FIG. 1 the vehicle movement detection circuit 10 is shown along with a wheel or drive shaft rotation sensor 12, warning display circuitry 14, apparatus to stow retractable equipment 16, additional remote start control circuitry 18, a starter motor 20 and an engine 22. At least one of the warning display circuitry 14, the apparatus to stow retractable equipment 16, the additional remote start control circuitry 18, the starter motor 20 and the engine 22 are located on a vehicle, as, for example, a vehicle (such as the vehicle 26 shown in FIG. 2) having a manual transmission. The vehicle movement detection circuit 10 has a first input terminal 28 for receiving a first output signal from the wheel or drive shaft rotation sensor 12, and a second input terminal 30 for receiving a second output signal from the wheel or drive shaft rotation sensor 12. A battery voltage input terminal 32 receives a battery voltage which, in the presently preferred embodiment, is present only when the ignition switch is on.

The battery voltage input terminal 32 is connected to the anode of a first diode 34, the cathode of which is coupled to chassis ground 36 of the vehicle through a capacitor 38, to the cathode of a second diode 40 and to a first terminal of a relay coil 42 of a double pole, double throw relay 44. A second terminal of the relay coil 42 is connected to the anode of the second diode 40 and to an output terminal 46 of the vehicle movement detection circuit 10 which is connected to any of the warning display circuitry 14, the apparatus to stow retractable equipment 16 and the additional remote start control circuitry 18, and to the collector 48 of a transistor 50 which, in the presently preferred embodiment, is a Darlington transistor.

It will be understood that the vehicle movement detection circuit 10 can be in an add-on module to a presently available remote starter vehicle module, such as the Audiovox Prestige Platinum System ATF685, or can be integrated into the remote start control circuitry such that there is only a single remote start in-vehicle module.

The transistor 50 has an emitter 52 connected to chassis ground 36, and a base 54 connected to a first terminal 56 of a secondary winding 58 of a transformer 60. A second terminal 62 of the secondary winding 58 is connected to chassis ground 36. A primary winding 64 of the transformer 60 has a second terminal 66 coupled through a resistor 68 to second input terminal 30. A severable wire loop 70 is connected across the resistor 68.

A first pole 72 of the relay 44 has an armature contact 74 connected to the first input terminal 28. A normally closed contact 78 of the first pole 72 is connected to a first terminal 76 of the primary winding 66. A normally open contact 80 of the first pole 72 is not connected to any other circuitry. A second pole 82 of the relay 44 has an armature contact 84 connected to the output terminal 46, a normally closed contact 86 not connected to any other circuitry and a normally open contact 88 connected to chassis ground 36.

In operation, the battery voltage input terminal 32 stores the battery voltage across a capacitor 38 so that when the battery voltage drops, as when the starter motor 20 begins starting the engine 22, the first diode 34 keeps the lower battery voltage from drawing down the voltage across the capacitor 38. The battery voltage passes through relay coil 42 to the collector 48 of the transistor 50 and to the output terminal 46. The second diode 40 prevents ringing in the coil when a voltage differential across the relay coil 42 is removed. There is no voltage differential across relay coil 42 until the transistor 50 is first turned on (i.e., conducting), and since the collector 48 of the transistor 50 is also the voltage at the output terminal 46, the output terminal 46 will have the battery voltage until transistor 50 is first turned on, assuming that neither the warning display circuitry 14, the apparatus to stow retractable equipment 16 nor the additional remote start control circuitry 18 is loading the output terminal 46. This battery voltage on the output terminal 46 does not activate the warning display circuitry 14, activate the apparatus to stow retractable equipment 16 and/or inhibit the additional remote start control circuitry 18 from starting the engine 22 of the vehicle.

The two output signals of the wheel or drive shaft rotation sensor 12, which in the presently preferred embodiment are differential output signals, received on input terminals 28 and 30 generally provide a pulsed voltage on input terminals 28 and 30 when there is a rotation. In the presently preferred embodiment the wheel or drive shaft rotation sensor 12 is either an anti-lock sensor (not shown) on one wheel 24 of the vehicle 26 or a drive shaft rotation detector (not shown) which is usually located in the transmission (not shown) of the vehicle.

The pulses from the wheel or drive shaft rotation sensor 12 are passed through the primary winding 66 of the transformer 60 until the transistor 50 is first turned on because the first input terminal 28 is connected to the first terminal 76 of the transformer 60 through the normally closed contact 78 of the first pole 72 of the relay 44. The secondary voltage of the transformer 60 is applied between the base 54 and emitter 52 of the transistor 50. Pulses that are sufficiently positive at the first input terminal 28 with respect to the second input terminal 30 cause transistor 50 to conduct and thereby apply the battery voltage and chassis ground 36 on the first and second terminals, respectively, of the relay coil 42.

When the relay coil 42 is energized by the battery voltage flowing to chassis ground 36, an armature 90 of the first pole 72 and an armature 92 of the second pole 82 move from the normally closed contacts 78 and 86, respectively, to the normally open contacts 80 and 88, respectively, of the first pole 72 and the second pole 82, respectively. This movement of the armature 90 of the first pole 72 disconnects the first input terminal 28 from the first terminal 76 of the primary winding 66 to thereby unload the differential output signals from the wheel or drive shaft rotation sensor 12. The movement of the armature 92 of the second pole 82 grounds the output terminal 46 thus enabling the warning display circuitry 14, enabling the apparatus to stow retractable equipment 16 and/or disabling the additional remote start control circuitry 18 from starting the vehicle engine. The grounded output terminal 46 provides a current path for the battery voltage to flow through the relay coil 42. The relay 44 thus remains in this state until the battery voltage on battery voltage input terminal 32 is removed, thus removing the voltage differential across the relay coil 42. In the presently preferred embodiment the battery voltage at the battery voltage input terminal 32 is removed when the ignition (not shown) of the vehicle is turned off.

The resistor 68 is to reduce the voltage across the primary winding 66 of the transformer 60 when the differential output signal from the wheel or drive shaft rotation sensor 12 is between about 5 and 10 volts as is usually the case with the anti-lock brake rotation sensors on vehicles. In this case the severable wire loop 70 is cut so that resistor 68 is not shorted out. If the wheel or drive shaft rotation sensor 12 output signal is less than about 5 volts, which is generally the case with drive shaft rotation detectors in the transmission of a vehicle, the severable wire loop 70 is left intact.

Therefore, the vehicle movement detection circuit 10 is put in readiness by the application of the battery voltage on the battery voltage input terminal 32, and the output terminal 46 is the battery voltage to disable (i.e., apply the battery voltage) the warning display circuitry 14, to disable the apparatus to stow retractable equipment 16 and/or to enable the additional remote start control circuitry 18. If there is an output signal from the wheel or drive shaft rotation sensor 12 of sufficient amplitude, the vehicle movement detection circuit 10 grounds the output terminal 46, and the warning display circuitry 14 is enabled, the apparatus to stow retractable equipment 16 is enabled and/or the additional remote start control circuitry 18 is disabled. Disabling the additional remote start control circuitry shuts off the starter motor 20 when the vehicle movement detector circuit 10 is coupled to the additional remote start control circuitry 18. If no rotation is sensed the output terminal 46 remains at battery voltage until rotation is sensed at which time the output terminal 46 is grounded. Thus, if there is a normal start of the engine 22, the output terminal 46 switches to ground when the vehicle 26 starts to move, and remains grounded until the battery voltage is removed from the battery voltage input terminal 32.

The wheel or drive shaft rotation sensor 12, whether it is a wheel rotation sensor or a drive shaft rotation sensor, provides a signal of sufficient amplitude to inhibit the starter motor when the vehicle has traveled less than about 4 to 6 inches.

Advantageously, the vehicle movement detection circuit 10 does not require expense mechanical hardware to be installed on the vehicle, nor does it require a specific procedure for turning off the vehicle. In addition, there is no additional vehicle movement sensor required for the remote starter.

The vehicle movement detection circuit 10 can also be used to alert a driver that a piece of equipment has not been properly stowed for travel when the driver first begins driving the vehicle. Turning now to FIG. 2, the vehicle 26, is shown as a recreational vehicle with an extendable and retractable satellite dish 94 and an extendable and retractable door step 96. The vehicle movement circuit operates as described above, but the warning display circuitry 14 may be responsive to, for example, circuitry to sense the status of a light bulb, or circuitry to sense the status of retractable equipment such as the retractable satellite dish 94 and the retractable door step 96. The vehicle movement detection circuit 10 acts to warn the driver and/or to stow the extended piece of equipment. Alternatively, or in addition, the vehicle movement detection circuit 10, upon detecting movement of the vehicle, may automatically stow the retractable equipment which is in an extended position, such as an extended satellite dish 94 or an extended door step 96, using the apparatus to stow retractable equipment 16.

Although the invention has been described in part by making detailed reference to a certain specific embodiment, such detail is intended to be, and will be understood to be, instructional rather than restrictive. It will be appreciated by those skilled in the art that many variations may be made on the structure and mode of operation without departing from the spirit and scope of the invention as disclosed in the teachings contained herein. For example, if the wheel or drive shaft rotation sensor 12 has only a single output signal (referenced to chassis ground 36), the single output signal would be connected to the first input terminal 28, and the second terminal 66 of the transformer 60 would be coupled to chassis ground 36 through the resistor 68 with the severable wire loop 70 initially across the resistor 68.

I claim:

1. A remote starter circuit for a vehicle equipped with a manual transmission comprising:
a) a rotation sensor which provides a first signal indicative of a movement of said vehicle; and
b) a switching device responsive to said signal for inhibiting a remote starter from attempting to start an engine of said vehicle when said first signal is present.

2. The remote starter circuit, according to claim 1, wherein said rotation sensor is a wheel rotation sensor.

3. The remote starter circuit, according to claim 1, wherein said rotation sensor is a drive shaft rotation sensor.

4. The remote starter circuit, according to claim 1, wherein said switching device comprises a relay, said relay further comprising:
a) a first pole having an armature completing a connection to a normally closed contact for completing a current path between said first signal and said switching device when said first signal indicates that said wheel is not rotating; and
b) said armature not completing said connection when said first signal indicates said wheel is rotating.

5. The remote starter circuit, according to claim 1, wherein said switching device comprises a relay, said relay further comprising a second pole having an armature for completing a connection to a normally open terminal of said relay for grounding said output terminal when said first signal indicates rotation.

6. The remote starter circuit, according to claim 1, further comprising:
a) a resistor in series between said first signal from said rotation sensor and said switching device; and
b) a severable wire loop across said resistor shorting said resistor when said wire loop is intact and not shorting said resistor when said wire loop is severed.

7. The remote starter circuit, according to claim 1, for sensing a rotation and inhibiting a starter motor control circuit of said remote starter further comprising:
a) a first input terminal for receiving said first signal;
b) a second input terminal for receiving a second signal from said rotation sensor;
c) said at least one input terminal coupled to a normally closed contact of a first pole of a relay, an armature terminal of said first pole coupled to a primary winding terminal of a transformer;
d) a secondary winding of said transformer coupled between ground and a base of a transistor, the collector of said transistor coupled to an output terminal of said circuit, and to a first terminal of a coil of said relay;
e) a second terminal of said coil coupled to a cathode terminal of a first diode, the anode terminal coupled to said first input terminal of said coil;
f) said second terminal of said coil coupled to ground through a capacitor and to a cathode of a second diode, the anode of which being coupled to a battery voltage of said vehicle; and
g) said first terminal of said coil coupled to an armature contact of a second pole of said relay; and a normally open contact of said relay coupled to ground.

8. The remote starter circuit, according to claim 7, comprising:
a) a resistor coupling a second input terminal from said wheel rotation sensor to a second terminal of said primary winding of said transformer; and
b) a severable wire loop across said resistor shorting said resistor when said wire loop is intact and for not shorting said resistor when said wire loop is severed.

9. The remote starter circuit, according to claim 7, wherein said transistor is an NPN Darlington transistor.

10. A remote starter circuit means for a vehicle equipped with a manual transmission comprising:
a) a rotation sensor means for providing a first signal indicative one of a movement of said vehicle; and
b) a switching means responsive to said first signal for inhibiting a remote starter from attempting to start an engine of said vehicle when said first signal is present.

11. The remote starter circuit means, according to claim 10, wherein said rotation sensor means is a wheel rotation sensor.

12. The remote starter circuit means, according to claim 10, wherein said rotation sensor means is a drive shaft rotation sensor.

13. The remote starter circuit means, according to claim 10, further comprising:
a) a resistor in series between said first signal from said rotation sensor means and said switching means; and
b) a severable wire loop across said resistor shorting said resistor when said wire loop is intact and not shorting said resistor when said wire loop is severed.

14. The remote starter circuit means, according to claim 10, for sensing a rotation and inhibiting a starter motor control circuit of said remote starter further comprising:
electrical contacts to the power source.
a) a first input terminal for receiving said first signal;
b) a second input terminal for receiving a second input signal from said rotation sensor;
c) said at least one input terminal coupled to a normally closed contact of a first pole of a relay, an armature terminal of said first pole coupled to a primary winding terminal of a transformer;
d) a secondary winding of said transformer coupled between ground and a base of a transistor, the collector of said transistor coupled to an output terminal of said circuit, and to a first terminal of a coil of said relay;
e) a second terminal of said coil coupled to a cathode terminal of a first diode, the anode terminal coupled to said first input terminal of said coil;
f) said second terminal of said coil coupled to ground through a capacitor and to a cathode of a second diode, the anode of which being coupled to a battery voltage of said vehicle; and
g) said first terminal of said coil coupled to an armature contact of a second pole of said relay; and a normally open contact of said relay coupled to ground.

15. A method for preventing a vehicle engine from being started by a remote starter when said vehicle has a manual transmission comprising the steps of:
a) sensing if there is one of wheel movement of said vehicle and drive shaft movement of said vehicle; and
b) providing an inhibit signal to said circuitry in said remote starter when there is one of said wheel movement and said drive shaft movement.

16. The method, according to claim 15, wherein said method of sensing comprises the steps of:
a) receiving an output signal from a sensor on one of said wheels of said vehicle and a transmission of said vehicle which indicates movement of said vehicle; and
b) energizing a relay in response to said sensor to provide said inhibit signal when said output signal indicates movement.

17. A vehicle movement detection circuit comprising:
a) a rotation sensor which provides a first signal indicative of a movement of said vehicle; and
b) a switching device responsive to said signal for inhibiting a remote starter from attempting to start an engine of said vehicle when said first signal is present.

18. The vehicle movement detection circuit, according to claim 17, wherein said rotation sensor is one of a wheel rotation sensor and a drive shaft rotation sensor.

19. The vehicle movement detection circuit, according to claim 17, wherein said switching device comprises a relay, said relay further comprising:
a) a first pole having an armature completing a connection to a normally closed contact for completing a current path between said first signal and said switching device when said first signal indicates that said wheel is not rotating; an
b) said armature not completing said connection when said first signal indicates said wheel is rotating.

20. The vehicle movement detection circuit, according to claim 17, wherein said switching device comprises a relay, said relay further comprising a second pole having an armature for completing a connection to a normally open terminal of said relay for grounding said output terminal when said first signal indicates rotation.
